(19) United States
(12) Patent Application Publication
(10) Pub. No.: US 2007/0274881 A1
(43) Pub. Date: Nov. 29, 2007

(54) Method For Treatment Of A Fluid Quantity Including Chemical Reacting Means Such As Combustible Materials And A Catalytic Device

(76) Inventor: Niels Bjarne Kampp Rasmussen, Lyngby (DK)

Correspondence Address: CANTOR COLBURN, LLP, 55 GRIFFIN ROAD SOUTH, BLOOMFIELD, CT, 06002, US

(21) Appl. No.: 10/580,918

(22) PCT Filed: Nov. 29, 2004
(86) PCT No.: PCT/DK04/00829

§ 371 Date: Mar. 13, 2007

(30) Foreign Application Priority Data
Nov. 28, 2003 (DK) PA 2003 01768

(51) Int. Cl. F01N 3/10; B01J 19/00; F16L 53/00

(52) U.S. Cl. 422/198; 60/299

(57) ABSTRACT

The invention relates to a method for treatment of a fluid quantity including chemical reacting means such as combustible materials above a certain minimum quantity in a catalytic device (1). The method comprises the steps of entering said fluid quantity into the catalytic device (1) through an inlet (2), controlling the temperature in one or more passage sections (3, 5) of said catalytic device (1) including at least one reaction passage section (4), by heat transferring, and emitting the treated fluid quantity from the catalytic device through an outlet (28). The invention also relates to a catalytic device and uses of the method and the catalytic device.

### BACKGROUND OF THE INVENTION

The invention relates to a method for treatment of a fluid quantity including chemical reacting means such as combustible materials and a catalytic device according to the preamble of claim 13 and uses hereof.

Most of the known catalysts for cleaning of exhaust gasses from internal combustion engines contain no internal heat exchange. This means that the maximum temperature in the catalyst depends on the inlet temperature in said catalyst. If the unburned gas components by combustion e.g. can increase the temperature in the catalyst by 200° C. an inlet temperature of 300° C. will result in a maximum temperature of 500° C., an inlet temperature of 400° C. will result in a maximum temperature of 600° C., etc. However, an inlet temperature of 200° C. does not necessarily result in a maximum temperature of 400° C. as the temperature at that time is too low for the reactions to take place and the catalyst will be wholly or partly inactive.

However, catalysts with internal heat exchange have been suggested in previous patent documents such as U.S. Pat. No. 6,207,116. The U.S. patent discloses a catalyst comprising a zig-zag folded metal plate coated with catalytic material. The folded plate is positioned in a container. The container comprises an inlet and outlet for gas in which the gas enters the container through the inlet. Hereafter the gas is directed along one side of the metal plate and subsequently returned along the other side before leaving the catalyst through the outlet. A heat exchange may take place from one side to the other side of the metal plate during the flow of the gas e.g. the returning gas heats the gas which has just entered the catalyst. However, the heat exchange is not enough to achieve satisfying and stabile temperature conditions inside the catalyst in the heating-up periods and thus, the catalyst comprises temperature regulating means in opposite ends of the container. The means may for example be electric coils connected to an electric power supply positioned outside the catalyst with the disadvantage of the electric energy use. Further, the connection for the electric coils is a significant disadvantage due to the price, complexity and vulnerability of the coils and the connections.

An object of the invention is to establish a catalytic device without the above-mentioned disadvantage, and especially a catalytic device with preferred and stabile temperature conditions.

### THE INVENTION

The invention relates to a method for treatment of a fluid quantity including chemical reacting means such as combustible materials above a certain minimum quantity in a catalytic device, said method comprises the steps of entering said fluid quantity into the catalytic device through an inlet, controlling the temperature in one or more passage sections of said catalytic device including at least one reaction passage section, by heat transferring, and emitting the treated fluid quantity from the catalytic device through an outlet.

Controlling the temperature in one or more of the passage sections by heat transferring is advantageous in that it provides for a more efficient catalytic device with preferred and stabile temperature conditions. Heat is transferred from areas in the catalytic device where the temperature is relatively high; typically areas where the catalytic process takes place, to areas where the temperature is relatively low; typically areas at or close to the inlet of the catalytic device. Hereby the catalytic device can handle a larger gas flow and still be effective.

An aspect of the invention provides for, a method wherein the temperature directly or indirectly controls the opened or closed position of at least one valve in said catalytic device.

This provides for an advantageous method of controlling the valve.

An aspect of the invention provides for, a method wherein said at least one valve controls the flow path of the fluid in said catalytic device.

It is advantageous to make the valve control the flow path of the fluid, in that it directs relatively hot or cold gases to areas of the catalytic device where it is needed, making the catalytic device more efficient.

An aspect of the invention provides for, a method wherein said at least one valve opens or closes a connection between said at least one reaction passage section and the outlet as a result of the temperature.

By making a valve open or close a connection between a reaction passage section and the outlet as a result of the temperature, provides for an advantageous method for leading relatively cold gases out of the catalytic device or making relatively hot gases stay longer in the catalytic device. This is advantageous in that it helps the catalytic device to reach an advantageous temperature level faster during a cold start, and when said temperature level is reached, it help to make the catalytic device more efficient.

An aspect of the invention provides for, a method wherein said at least one valve opens or closes in response to the temperature of the fluid flowing by temperature dependent connection means in said at least one valve.

It is advantageous to provide the valve with temperature dependent connection means in the valve, in that it provides for a inexpensive and reliable method of controlling the valve.

An aspect of the invention provides for, a method wherein the fluid always flows through, by or in the proximity of the temperature dependent connection means.

Making the fluid always flows through, by or in the proximity of the temperature dependent connection means is advantageous, in that the temperature dependent connection means can respond faster to changes in the gases temperature.

An aspect of the invention provides for, a method wherein a valve control signal is established by measuring the temperature inside one or more of said passage sections, one or more turning chambers and/or said inlet.

By controlling the valve by a temperature signal provides for an accurate and efficient method of controlling the valve.

An aspect of the invention provides for, a method wherein the valve control signal is established on the basis of the temperature difference between one or more of said passage sections, one or more turning chambers and/or said inlet.

This provides for an advantageous embodiment of the invention.

An aspect of the invention provides for, a method wherein the valve control signal is established in relation to a predefined temperature threshold signal.

By establishing the valve control signal in relation to a predefined temperature threshold signal provides for an inexpensive method of establishing the signal, in that only one temperature measurement is needed.

An aspect of the invention provides for, a method wherein said at least one reaction passage sections heat exchange with a main heat transfer passage section, and/or where said at least one reaction passage sections heat exchange with one or more preceding inlet passage sections and/or one or more succeeding outlet passage sections.

Making heat exchange between the different passage sections is advantageous in that heat is transferred to areas of the catalytic device where it is needed.

An aspect of the invention provides for, a method wherein the fluid quantity is directed through the succeeding passage sections in counterflow.

Directing the gases through the succeeding passage sections in counterflow is advantageous, in that heat is transferred to areas of the catalytic device where it is needed.

An aspect of the invention provides for, a method wherein further combustible material is added directly or indirectly to the catalytic device.

Hereby it is possible even with small amounts of additional fuel to raise the temperature in order to make the catalytic device more stable and to save device material e.g. the device can be made smaller and still be effective.

The invention further provides for a catalytic device comprising integrated heat transfer means for controlling the temperature in one or more of the at least one passage sections.

Providing the catalytic device with integrated heat transfer means for controlling the temperature is advantageous in that the catalytic device becomes more efficient e.g. it can handle a larger gas flow. Further, the catalytic device may reach the temperature level, at which the catalytic process begins, sooner or it is less affected by changes in the gas flow or the quality thereof.

The catalytic device can be used for cleaning of any fluid such as every gas, air or liquid quantity comprising chemical reacting means such as combustible materials above a certain minimum quantity. The invention will possibly also be of use within the fuel cell technology and in the industry where exothermal or endothermal reactions take place.

Further, the catalyst can be designed to work at a very specific temperature, by which it is possible, partly to ensure a better and safer burnout of the unburned components, and partly to save expenses for catalytic materials.

The technique can be used for cleaning of any fluid such as every gas, air or liquid quantity comprising chemical reacting means such as combustible materials above a certain minimum quantity.

It shall be emphasised that the term “catalytic material” should be understood as material that reacts with the combustible materials and/or enhances the reaction of the combustible materials e.g. speeds up the process without reacting with the combustible materials as such.

In an aspect of the invention, said catalytic device comprises one passage section. Hereby, it is possible to make a structural simpler catalytic device with advantageous outer dimensions.

In an aspect of the invention, said means includes heat transferring rods and/or plates e.g. between 20 and 5000 rods preferably between 50 and 1000 rods and/or between 5 and 1000 plates preferably between 10 and 200 plates. Hereby, the catalyst can be made smaller as the heat transferring rods or plates ensure that heat is directed and controlled.

Hereby it is possible to transfer the heat in an advantageously manner from the initial area of catalytic process to the rest of the relevant areas of the catalytic device. The number of heat transferring rods and/or plates ensures that the catalytic process is transferred to the rest of the relevant areas in a focused and controlled manner.

In an aspect of the invention, said heat transferring rods and/or plates are made of a material with god heat transferring qualities such as cobber, steel, aluminium or other metals. The high heat transferring quality of the heat transferring rods and/or plates are important in ensuring low volume and weight and thus low interference in the flow resistance of the catalytic device.

In an aspect of the invention, said catalytic device comprises at least two passage sections.

Making the catalytic device with at least two passage sections is advantageous in that it enables efficient heat transfer between the different temperature areas in the catalytic device.

In an aspect of the invention, said means control the temperature by high heat capacity established by high mass of the device in relation to the mass flow of the fluid.

Hereby it is obtained that the maximum temperature in the catalytic device is always nearly constant whatever the inlet temperature, but assuming a certain minimum inlet temperature and minimum amount of combustible material. Further, the catalytic device can be designed to work at a very specific temperature, as an example at 600° C., by which it is possible, partly to ensure a better and safer burnout of the unburned components, and partly to save expenses for catalytic materials as a catalyst that is designed for a certain temperature can be made from materials that are less expensive than the materials for a catalyst that has to work over a large temperature range.

Furthermore when the catalytic device has a high heat capacity hotspots is avoided. Hotspots occur when the catalytic process produces so much heat that the internal temperature of the device in certain areas is raised to a level permanently damaging the device. If the catalytic device has a high heat capacity the heat is absorbed and/or transferred to colder areas of the device.

In an aspect of the invention, said device includes at least one outer layer of insulating.

In an aspect of the invention, said means include positioning of said passage sections in order to form at least one internal heat exchanger with mutual heat exchange between the sections.

In an aspect of the invention, said means for controlling the temperature includes at least one temperature controlled valve.

By providing the catalytic device with at least one temperature controlled valve it is possible to control the temperature in the catalytic device very efficiently.

In an aspect of the invention, said catalytic device comprises three passage sections. Hereby is achieved an advantageous relation between price and size and the efficiency of the device. The advantageous relation especially makes the catalytic device relevant in relation to vehicles such as cars and trucks. Furthermore an outer layer of insulation can be avoided, in that the third passage insulates the device.

In an aspect of the invention, said catalytic device comprises four passage sections.

In an aspect of the invention, said fourth passage section is a last outlet passage section surrounding the previous passage sections. Hereby it is possible to surround and create an isolation of the previous three passages from the exterior temperature. Consequently, the normal quantity of outer insulation layer may be diminished or avoided.

In an aspect of the invention, at least one turning chamber between two of said passage sections comprises a connection to the outlet, such as an exhaust pipe section, controlled by said at least one temperature controlled valve. Hereby it is possible to heat up the whole catalytic device rather quickly by directing the gas to different sections of the catalytic device as a result of the gas and catalytic device temperature.

In an aspect of the invention, each of said at least one temperature controlled valve comprises a closing member and temperature dependent connection means connecting said closing member and an anchoring point.

In an aspect of the invention, said temperature dependent connection means is a spring made in bimetal or a similar temperature dependent material. Hereby it is possible to establish a temperature dependent connection that is both simple and reliable.

In an aspect of the invention, said temperature dependent connection means partly or totally is positioned in the outlet e.g. in an outlet pipe such as the outlet passage sections, valve pipe section, exhaust pipe section or the outlet pipe section.

In an aspect of the invention, said outlet pipe comprises a valve pipe section including at least one valve, an outlet pipe section connected to the outlet chamber, in which both pipe sections are connected to said exhaust pipe section.

In an aspect of the invention, said temperature dependent connection means partly or totally is positioned in proximity of the connection between said pipe sections or in the exhaust pipe section.

In an aspect of the invention, said device includes temperature-measuring means measuring the temperature inside one or more of said passage sections, one or more turning chambers and/or said inlet. Hereby it is possible to control the flow and direction of the gas in the catalytic device, and thus the temperature in the catalytic device, with a higher accuracy.

In an aspect of the invention, valve control means controls the position of said at least one temperature controlled valve on the basis of temperature values from said temperature-measuring means. Hereby it is possible to direct only a fraction of the gas flow to a different section of the catalytic device or increase or decrease the transfer of gas flow to the section.

In an aspect of the invention, said at least one reaction passage sections establishes a heat exchanger with a main heat transfer passage section, and/or said at least one reaction passage sections establishes a heat exchanger with one or more preceding inlet passage sections and/or one or more succeeding outlet passage sections. The catalyst can thus be designed to work at a very specific temperature, by which it is possible, partly to ensure a better and safer burnout of the unburned components, and partly to save expenses for catalytic materials i.e. an advantageous relation between price and size and the efficiency of the device.

In an aspect of the invention, said one or more inlet passage sections is positioned above, alongside or outside said reaction passage section e.g. by surrounding said section. Hereby is achieved an advantageous preheating of the inlet fluid before entering the reaction passage section.

In an aspect of the invention, said one or more outlet passage sections is positioned above, alongside or outside said reaction passage section e.g. by surrounding said section. Hereby it is possible to preheat the fluid in some of the reaction passage section by the outlet passage section fluid.

In an aspect of the invention, said reaction passage section is positioned above, alongside or outside said main heat transfer passage section e.g. by surrounding said section. Hereby it is possible to achieve a preferred and advantageous embodiment of the invention.

In an aspect of the invention, said reaction passage section heat exchanges with said main heat transfer passage section of said at least two passage sections.

In an aspect of the invention, said reaction passage section heat exchanges with said main heat transfer passage section in counterflow.

In an aspect of the invention, said reaction passage section heat exchanges with said one or more previous inlet and/or succeeding outlet passage sections.

In an aspect of the invention, said reaction passage section heat exchanges with said one or more inlet passage sections in counterflow.

In an aspect of the invention, said reaction passage section heat exchanges with said one or more outlet passage sections in concurrent flow.

In an aspect of the invention, said device comprises at least one layer of insulation between said at least two passage sections. Hereby, it is possible to reduce the heat exchange between the passage sections.

In an aspect of the invention, said at least one layer of insulation is positioned between said reaction passage section and said one or more inlet passage sections.

Hereby, it is possible to reduce the heat exchange between the fluid flows in preferred passage sections.

In an aspect of the invention, the cross-sectional area of said reaction passage section is between 0.5 and 100 times, such as between 10 and 25 times, preferably about 20 times, the cross-sectional area of said main heat transfer passage section and/or said inlet or outlet passage sections are between 0.5 and 100 times, the cross-sectional area of said main heat transfer passage section. Hereby is achieved an advantageous relation between the passage sections.

In an aspect of the invention, the cross-sectional area of the main heat transfer passage section is between 0.5 and 10 times, such as 1.5 to 2.5 times, preferably about 2 times, the cross-sectional area of the inlet of the catalytic device, said inlet pipe being the exhaust pipe for the connected internal combustion engine. Hereby is achieved an advantageous embodiment of the invention.

In an aspect of the invention, at least one of said passage sections comprises one or more wall flow filters with numerous porous walls allowing fluid quantity to penetrate through the walls. Hereby is achieved an advantageous embodiment of the invention.

In an aspect of the invention, said at least one passage sections, such as said main heat transfer passage section, comprises one or more substantially parallel pipes. Hereby it is possible to achieve a preferred and advantageous embodiment of the invention.

In an aspect of the invention, said main heat transfer passage section is integrated as a number of pipes in said reaction passage section. Hereby is achieved a very compact device with an enhanced heat exchange between the sections.

In an aspect of the invention, said number of pipes is between 20 and 5000 pipes and preferably between 50 and 1000 pipes. Hereby is achieved a preferred and enhanced heat exchange or transfer between areas or sections.

In an aspect of the invention, said pipes form symmetrical patterns such as triangular, quadrangular or similar patterns or random patterns. Hereby is achieved a preferred relation between heat exchange and flow resistance.

In an aspect of the invention, said pipes is surrounded by catalytic material deposited on one or more carrier means. By surrounding the pipes is achieved a preferred and homogenised heat exchange from the section passage comprising carrier material to the pipes.

In an aspect of the invention, said pipes comprise a circular, an oval, a triangular, a four-sided or any similar regular or irregular cross sectional shape. By the shape is achieved a preferred relation between the shape, flow resistance and production price.

In an aspect of the invention, at least one of said two passage sections, such as said main heat transfer passage section, comprises one or more lamellar plates.

In an aspect of the invention, said one or more lamellar plates form non-circular canals e.g. with a cross sectional shape formed by triangles, four sided shapes, combinations hereof or similar shapes.

In an aspect of the invention, indentations in the surface of said one or more lamellar plates form longitudinal or diagonal patterns.

In an aspect of the invention, said catalytic material is deposited on one or more carrier means in at least one of said at least one passage sections. Depositing the material on carrier means enhanced flexibility as the shape and surface of the carrier means may be designed to the relevant application e.g. in order to achieve large surface, low pressure drop, high heat transfer, small sized catalytic device or the like. Further, it is possible to fit the surface area and pressure drop through the device for the application in question.

In an aspect of the invention, said one or more carrier means are made in metal, ceramic, glass or other heat resistant materials as well as combinations of the mentioned materials. Hereby is established material that may tolerate the high temperatures of the catalytic device in longer periods without sustaining cracks or rupturing. Further, it is possible to find the exact best fit material for the application in question.

In an aspect of the invention, said one or more carrier means include at least one shape such as spherical, cylindrical or quadrangular shapes as well as saddle, ring, regular or irregular shapes. Hereby it is possible to fit the surface area and pressure drop through the device for the application in question.

In an aspect of the invention, said one or more carrier means include a number of regular or irregular pellets or balls in layers across one of said passage sections, each layer being positioned perpendicularly between two adjacent pipes, and each of said layers comprising 2 to 6 pellets, such as 2 to 4 and preferably between 2 and 3. Hereby it is possible to achieve a low pressure drop through the device and a high heat transfer to the pipes.

In an aspect of the invention, said one or more carrier means include monoliths or fibres. Hereby it is possible to achieve a large surface without creating large pressure drops through the sections.

In an aspect of the invention, said fibres, deposit with said catalytic material form a tangled bundle of fibres partly or totally filling one or more of said passage sections.

Hereby it is possible to create a very large surface and a relatively low pressure drop in the catalytic device.

In an aspect of the invention, said monoliths or fibres, deposit with said catalytic material form longitudinal monoliths or fibres inside one or more of said at least one passage sections. Hereby it is possible to reduce the pressure drop through the device because of the orientation of the monoliths or fibres.

In an aspect of the invention, said reaction passage section of said at least one passage sections comprises one or more kinds of said catalytic material deposit on said carrier means.

In an aspect of the invention, said one or more inlet and/or outlet passage sections of said at least two passage sections comprises one or more kinds of said catalytic material deposit on said carrier means.

In an aspect of the invention, said at least one passage sections comprise combined carrier means including wall flow filters, fibres, pellets or balls and/or monoliths e.g. ⅓ passage section as wall flow filters and the rest of the section as fibres, pellets or balls or monoliths.

In an aspect of the invention, said combined carrier means are positioned in continuation of each other through one or more of said at least one passage sections. Hereby it is possible to establish enhanced devices with the advantages of all the types of carrier means.

In an aspect of the invention, said catalytic material includes metal or metal alloys from the Platinum metal group such as Platinum (Pt), Palladium (Pl), Rhodium (Rh) or combinations hereof. Hereby it is possible to create catalytic devices with optimal cleaning abilities for fluids such as exhaust gases from internal combustion engines.

In an aspect of the invention, said catalytic material includes metal oxides such as Gold (Au), Platinum (Pt), Silver (Ag), Aluminium (Al), Lead (Pb), Zirconium (Zr), Copper (Cu), Cobalt (Co), Nickel (Ni), Iron (Fe), Cerium (Ce), Chrome (Cr), Tin (Sn), Manganese (Mn) and Rhodium (Rh) Oxides or combinations hereof. The use of metal oxides as catalytic material makes it possible to create more price efficient catalytic devices.

In an aspect of the invention, said catalytic material includes combinations of metal or metal alloys from the Platinum metal group and metal oxides. Hereby it is possible to optimise the performance and characteristics of the catalytic material by using the advantages of both material types

In an aspect of the invention, further combustion material is added to the catalytic device, e.g. through a fuel line connected to the fuel tank and the fuel supplying means, or through adding further combustion material to the fluid quantity.

In an aspect of the invention, material establishing a high temperature is added to the catalytic device in order to clean said catalytic device e.g. through adding combustible gas to the fluid quantity. Hereby it is possible even with small amounts of additional fuel to raise the temperature in order to make the catalytic device more stable and to save device material e.g. the device can be made smaller and still be effective.

In an aspect of the invention, at least one of said at least one passage sections comprises at least one cleaning area free of rods, plates or pipes.

### FIGURES

The invention will be described in the following with reference to the figures in which

FIG. 1 illustrates an application including a catalytic device,

FIG. 2 illustrates a catalytic device with a longitudinal section with two passages,

FIG. 3 illustrates an embodiment of the catalytic device,

FIG. 4 illustrates another embodiment of the catalytic device,

FIGS. 5a and 5b illustrate examples of temperature curves for the embodiments of the catalytic device in FIG. 3 and 4,

FIG. 6 illustrates a sectional view through the catalytic device of FIG. 3, 4, 12 or 13,

FIG. 7 illustrates a flow diagram of a preferred embodiment of the invention,

FIG. 8 illustrates a first preferred embodiment of the catalytic device with temperature valve control means,

FIG. 9 illustrates schematically the first preferred embodiment of FIG. 8,

FIG. 10 illustrates schematically the embodiment with the temperature valve control means positioned differently,

FIG. 11 illustrates a preferred embodiment of the temperature valve control means,

FIG. 12 illustrates the integration of the temperature valve control means in an embodiment of the catalytic device,

FIG. 13 illustrates temperature measurement and subsequent control of the valve in an embodiment,

FIG. 14 illustrates a further preferred embodiment of the catalytic device,

FIG. 15 illustrates an even further preferred embodiment of the catalytic device

FIGS. 16a and 16b illustrate a further embodiment of the catalytic device,

FIG. 17 illustrates a sectional view of an even further embodiment of the catalytic device,

FIG. 18 illustrates a passage section with and without a corrugated shape,

FIG. 19 illustrates a special embodiment in which wall flows filters are integrated into the catalytic device according to the invention,

FIG. 20 illustrates a sectional view of a passage section including a number of carrier means in shape of longitudinal fibres deposited with catalytic material,

FIG. 21 illustrates a sectional view of passage sections including a number of regular or irregular shaped carrier means deposited with catalytic material,

FIG. 22 illustrates a sectional view of a passage section comprising a longitudinal monolith structure,

FIG. 23 illustrates a sectional view of a passage section comprising a structure with wall flow filters and other carrier means,

FIG. 24 illustrates schematically an embodiment of the catalytic device including different characterizing data of the device,

FIG. 25 illustrates a further application including a catalytic device according to the invention,

FIG. 26 illustrates another embodiment of a catalytic device seen from above, and

FIG. 27 illustrates an array of catalytic devices in a large plant as seen from above.

### DETAILED DESCRIPTION

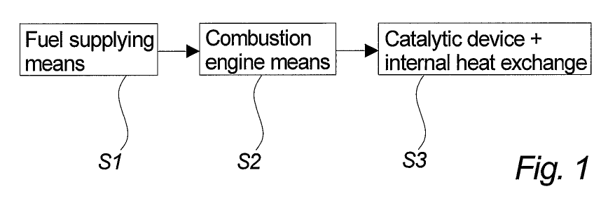

FIG. 1 illustrates schematically an application including a catalytic device.

The application includes combustion and fuel supplying means S1, S2 in which the fuel supplying means S1 supplies a combustible fuel to the combustion means S2. After the combustion at the combustion means, any exhaust gas of the combustion is directed to a catalytic device with internal heat exchange. The catalytic device with internal heat exchange may also be named a recuperative catalytic device.

The catalytic device can among other things be used for vehicles with an internal combustion engine such as an engine fuelled by petrol, diesel, natural gas, bottled gas or any similar fuels. The combustion engine S2 is supplied with fuel from a fuel tank or container by the help of a fuel pump S1 pumping the fuel.

Further uses of the catalytic device may be in connection with stationary engines such as combustion engines at power plants, e.g. combined heat and power plants, using petrol, diesel, coal, natural or bottled gas or any similar fuels or in e.g. in connection with waste incineration plants.

The exhaust gases of the combustion means include a certain amount of unburned gas components that can be converted in the catalytic device. The catalytic device can be designed to convert unburned hydrocarbon (UHC), carbon monoxide (CO), nitric oxides (NOₓ) and/or particles from combustion engines.

A further use of the device may be in the industry. Whenever an exothermal process needs external heating before the process to make the process effective the device according to the invention may be used to save energy in this process, e.g. in fuel conversion processes.

Another use of the device may be in connection with fuel cell technology. At any exothermal process in the fuel cells or in connection with the fuel cells in which external heating is needed before the process the device according to the invention may be used for implicit internal control of the temperature.

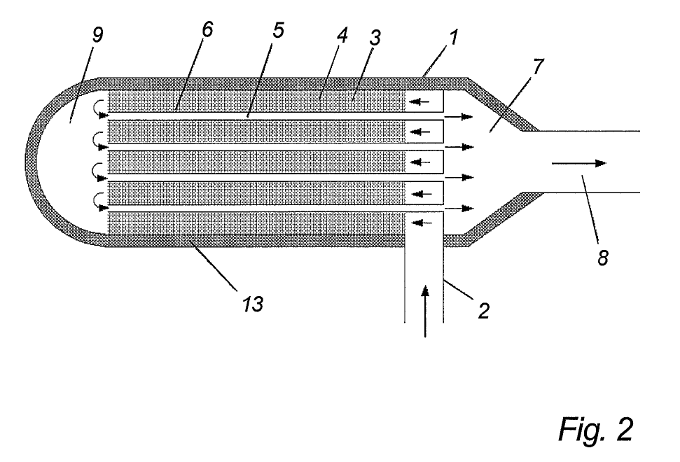

FIG. 2 illustrates a longitudinal section of a catalyst 1. From the inlet 2 the gases pass into the first passage 3 with catalytic materials 4 (illustrated as hatched areas) in which the gases react at the same time as they heat exchange with the last passage 5 through the exchange surface 6 before the outlet chamber 7 and the outlet 8.

The inlet and/or the outlet may be connected to one or more further passage sections in order to establish at least three passage sections.

The maximum temperature may be obtained in the turning chamber 9 in which the gases turn form the first passage section 3 to the second passage section 5. The temperature in the turning chamber 9 will be the temperature of the gases when these have completed reacting in the passage section 3. If the temperature inside the passage section 3 is high, the gases will react in the beginning of this passage and the heat exchange between the gases in the second passage section 5 and in the first passage section 3 will be at a minimum.

If the temperature inside the first passage section 3 is low, the gases will react near the outlet of this passage section. The temperature difference between the gases in the second passage section 5 and in the passage section 3 will thus be big throughout the entire length of the heat exchanger and the heat exchange will be at a maximum by which the gases in the passage section 3 is heated by the gases in the passage section 5 in order to react at the end of the passage section 3.

The walls that are part of the passage sections and the heat exchanger are preferably made in materials with good heat conductivity such as metals or metal alloys e.g. steel or aluminium.

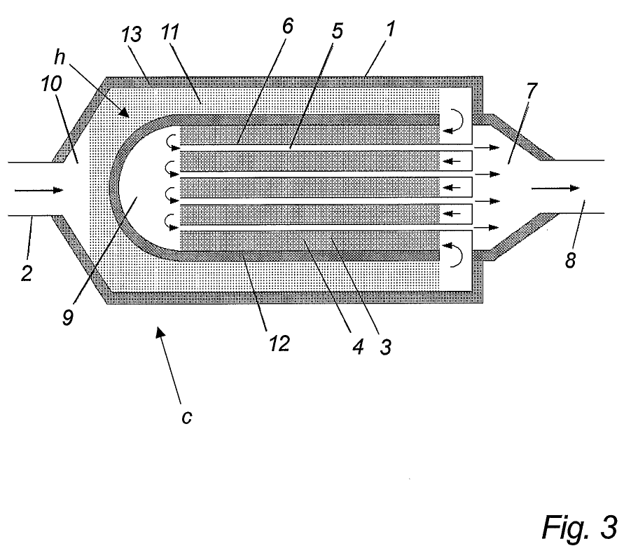

FIG. 3 illustrates an embodiment of the catalytic device where the gas from the inlet pipe 2 enters the container c comprising at least three passage sections forming a heat exchanger h. At the entrance, the gas meets the inlet chamber 10 after which it is distributed in the inlet passage section 11 in the catalytic device 1. If the conditions for reaction are met, the first reactions will start and maybe be finished in this passage section 11 after which the rest of the passage sections 3 and 5, the main reaction and the main heat transfer passage sections, will obtain the same maximum temperature. To the extent that the temperature inside the inlet chamber 10 is lower, the reaction of the gases will move to the main reaction passage section 3, and the rest of the catalytic device works hereafter as described above concerning FIG. 2.

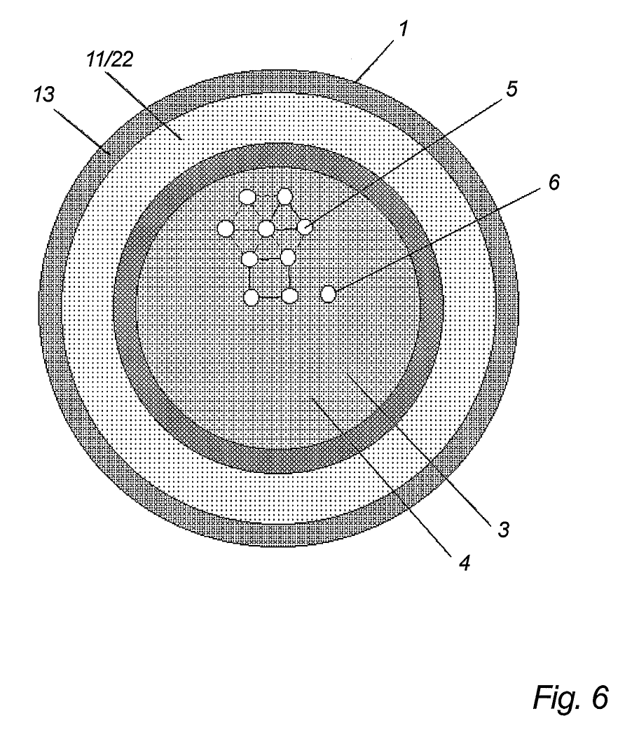

The passage section is illustrated as four pipe positioned above each other. However, it shall be emphasised that the number of pipes usually are between 20 and 5000 and preferably between 50 and 1000 pipes. The pipes may be positioned randomly or in one or more patterns as will be further explained below e.g. in connection with FIG. 6.

The gas is guided through the catalytic device by the at least two passage sections that have a mutual internal heat exchange. In the second passage, the main reaction passage section, there are catalytic materials 4 (illustrated with similar hatched areas as FIG. 2) of one or more kinds, in which the gas can react, and in which the gases heat exchange with the succeeding main heat transfer passage section. Hereby is obtained an internal heat exchange placed in the catalytic device. This means that the catalytic device and the heat exchanger h are fully integrated.

The outlet temperature of the gas may still be the same as in a conventional catalyst. However, the internal heat exchange results in the temperature reaching a maximum preferably in the turning chamber between main reaction passage section and the main heat transfer passage section. The specific design makes the heat exchanger more efficient the slower the chemical reactions in the catalytic material are, and vice versa. Hereby, a nearly constant temperature is ensured and especially in the turning chamber between main reaction passage section and the main heat transfer passage section. The constant temperature may be higher than the outlet temperature for the catalytic device.

If the chemical reactions are fast, the heat exchanger will almost be inactive as all reactions are completed in the first part of the catalytic material in the main reaction passage section.

If the chemical reactions are slow, the heat exchanger will especially become active as the chemical reactions will take place in the last part of the catalytic material in the main reaction passage section.

The catalytic device will, by itself, set itself for the right temperature so that all reactions precisely can be completed in the catalytic device, and the temperature will not increase further. The catalytic device is therefore self-regulating with an almost constant maximum temperature in which the constant maximum temperature usually will occur in the turning chamber 9.

Further, in this embodiment the inlet and the main heat transfer passage sections can be with or without catalytic material.

Also in this embodiment, the catalytic device may comprise an insulating material 12 between the inlet passage 11 and the main reaction passage section 3 in order to reduce or control the heat exchange between the gases in these passages.

The catalytic material can be of one or several kinds preferably from the Platinum metal group such as Platinum (Pt), Palladium (Pl), Rhodium (Rh) or similar metals or metal alloys that are well-known by skilled persons within the area of oxidation catalytic material in catalytic devices. The different type of metals or metal alloys may be used together in a catalytic device e.g. Rhodium for nitrogen oxide reduction and Platinum and Palladium for carbon monoxide reduction.

Further, catalytic material involving different types of metal oxides may be used. Examples of metal oxides are Aluminium (Al), Gold (Au), Silver (Ag), Lead (Pb), Zirconium (Zr), Copper (Cu), Cobalt (Co), Nickel (Ni), Iron (Fe), Cerium (Ce), Chrome (Cr), Tin (Sn), Manganese (Mn) and Rhodium (Rh) Oxides.

Even further, a combination of different catalytic materials may be used such as metal and/ metal alloys together with one or more metal oxides as described above. The combination may be achieved by mixing the different materials or by positioning the different materials one after another in the catalytic device.

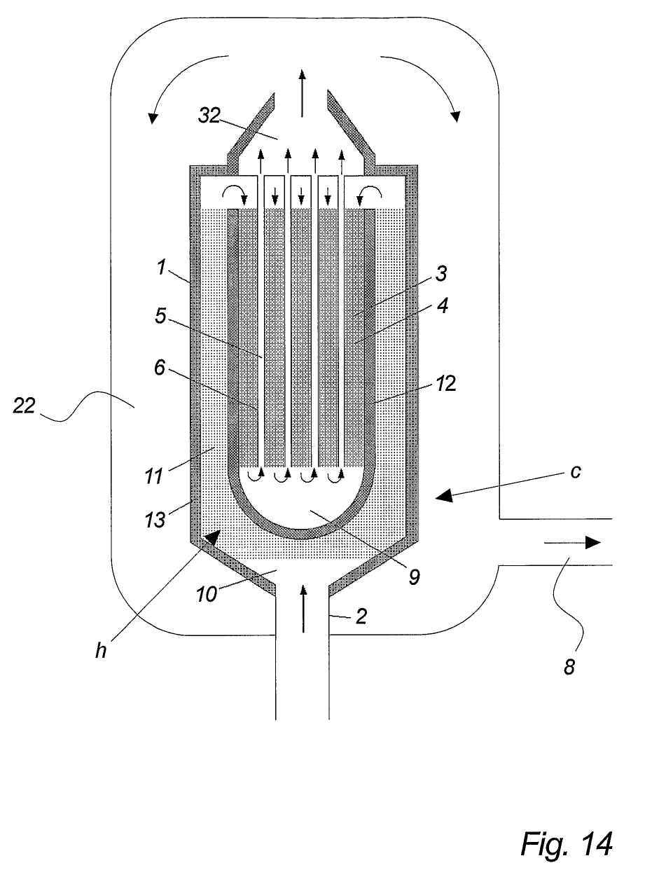

The catalytic device may comprise more than three passage sections e.g. four, as illustrated in FIG. 14, or five sections in which more sections however involve a significant increase in the structural complexity of the device as well as the costs. In an embodiment the catalytic device comprises a last passage section, a second-last passage section and at least two previous sections. The last and second-last and first passage sections correspond, respectively, to the main heat transfer, main reaction and the inlet passage section of the embodiment comprising three passages. The intermediate passage sections in the present embodiment may in construction correspond to any of the three passage sections e.g. comprising catalytic material or not. Further, any construction details in connection with the passage sections revealed above or below may be integrated in the intermediate passage sections.

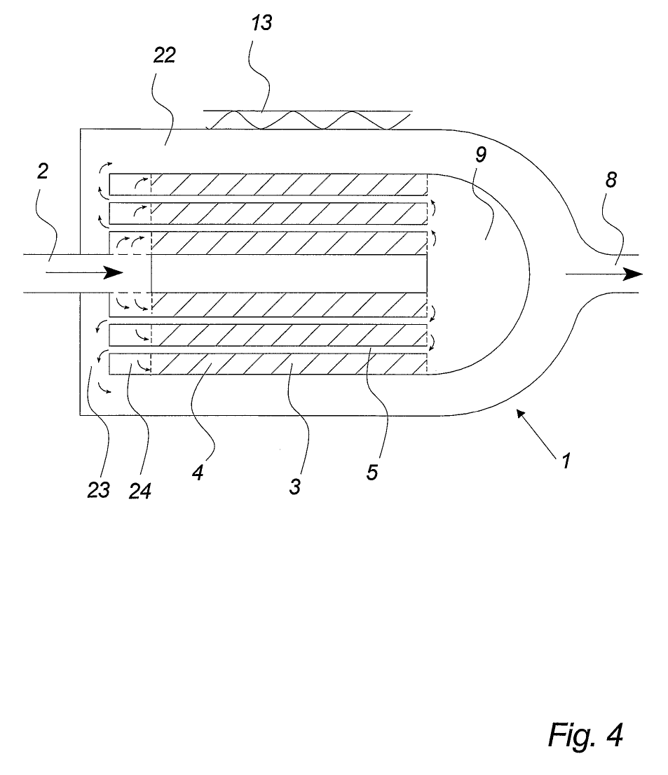

FIG. 4 illustrates another embodiment of the catalytic device.

At the inlet 2, the gas is distributed to enter the main reaction passage section 3. In this section 3 the reaction takes place and the maximum temperature is achieved in the succeeding turning chamber 9 in which the gases turn from the main reaction passage section 3 to the main heat transfer passage section 5. As in the previous embodiments the gases in the main heat transfer passage section 5 exchange heat to the gases in the main reaction passage section 3 to heat up these gases. From main heat transfer passage section 5 the gases enter the second turning chamber 23 from which the gases enter the outlet passage section 22. Flowing in the outlet passage section the gases further exchange heat to the inlet part of the main reaction passage section 3 and thus helping to increase the temperature level of the reaction in the passage section 3. The temperature controlling characteristic and many of the other characteristics, such as the number of pipes and pattern shapes, of this embodiment is the same as in the previous embodiment of FIG. 3.

If the embodiment of FIG. 4 was a stationary catalytic device 1 to be used in e.g. an industrial plant, a power plant or other the temperature could also be controlled just by the fact that the catalytic device 1 is large and well insulated. If the catalytic device 1 itself weighed 400 kg and was further provided with e.g. 400 kg. of catalytic material, the heat capacity of the catalytic device 1 compared to the heat capacity of the mass flow of gases would be very large. This means that the catalytic device 1 is unaffected by changes in the gas flow or changes in the heat produced by the catalytic process.

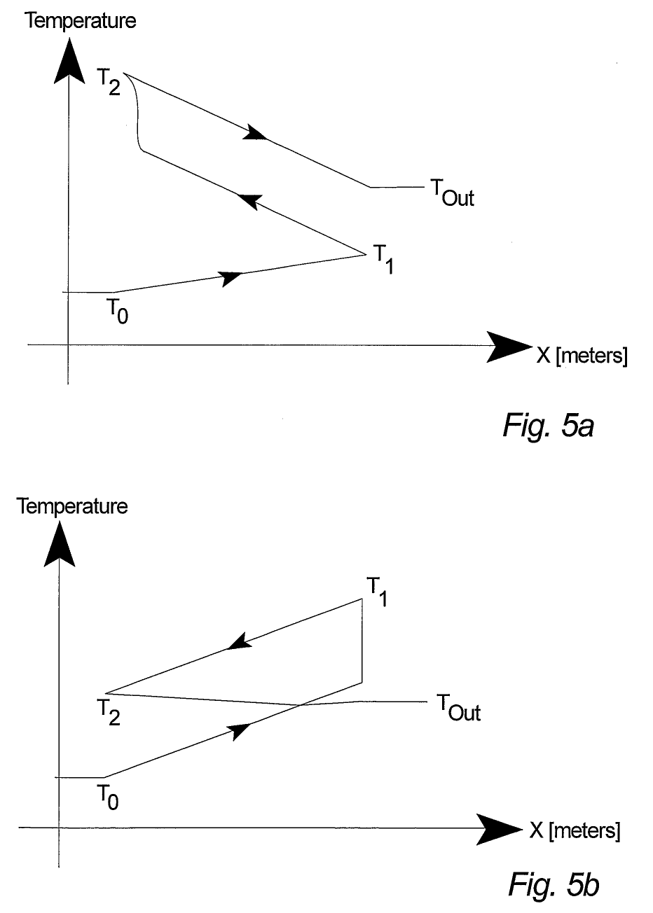

FIGS. 5a and 5b illustrate examples of temperature curves for the embodiments of the catalytic device in FIGS. 3 and 4.

FIG. 5a illustrates a temperature curve for the catalytic device of FIG. 3 in which the gas enters through the inlet 2 with a temperature T₀. As the gas is directed through the inlet passage channel the gas in the succeeding main reaction passage section will preheat the gas to a temperature T₁ at the turning chamber before the main reaction passage section. The gas is further preheated in the main reaction passage section by the counterflowing gas in the main heat transfer passage section. At the end of the main reaction passage section the combustible material of the gas reacts with the catalytic material and the temperature jumps to T₂ just before entrance to the main heat transfer passage section. The gas temperature drops as the gas flows through the main heat transfer passage section and ends with Tₒᵤₜ at the outlet of the catalytic device.

FIG. 5b illustrates a temperature curve for the catalytic device of FIG. 4 in which the gas enters through the inlet 2 with a temperature T₀. As the gas is directed through the main reaction passage section the gas will be preheated by gas in the succeeding main heat transfer and outlet passage sections. The outlet passage section will only add to the preheating until the gas in the main reaction passage section has reached the temperature of the outlet passage section. At the end of the main reaction passage section the combustible material in the gas reacts with the catalytic material and courses a temperature jump. In the turning chamber between the main reaction and the main heat transfer passage section the temperature T₁ is reached. The gas is counterflowing in the heat transfer passage section and transferring heat to the gas in the main reaction passage section and thus has the temperature dropped to T₂ at the entrance to the outlet passage section.

FIG. 6 illustrates a sectional view through the catalytic device of FIG. 3, 4, 12 or 13. It applies for these embodiments (and the embodiment of FIG. 2) that outermost under the last layer of plates, an insulating layer 13 can be installed in order to reduce the heat loss to the surroundings.

Further, the figure illustrates the inlet passage section 11 or the outlet passage section 22 surrounding the main reaction and the heat transfer passage sections 3, 5. The main reaction passage section is illustrated as a pipe with a circular cross section in which the section comprises catalytic material 4 (illustrated with similar hatched areas as FIG. 2) and the main heat transfer passage section 5. The main heat transfer passage 5 is illustrated as a few number of pipes positioned in different patterns. However, it shall be emphasised that the number of pipes preferably are between 20 and 5000 (as stated above) and that the illustrated pipes (on this and the previous figure) only are a section of the total number of pipes. The illustrated patterns include triangular, quadrangular or similar symmetrical patterns (illustrated with dotted/solid lines) in which one or combinations of more patterns may be used in a passage section of the catalytic device. The patterns may also be more or less random or freely positioned in the passage section of the catalytic device.

The patterns of pipes and the hydraulic diameter between the pipes are preferably chosen in order to achieve a low pressure loss.

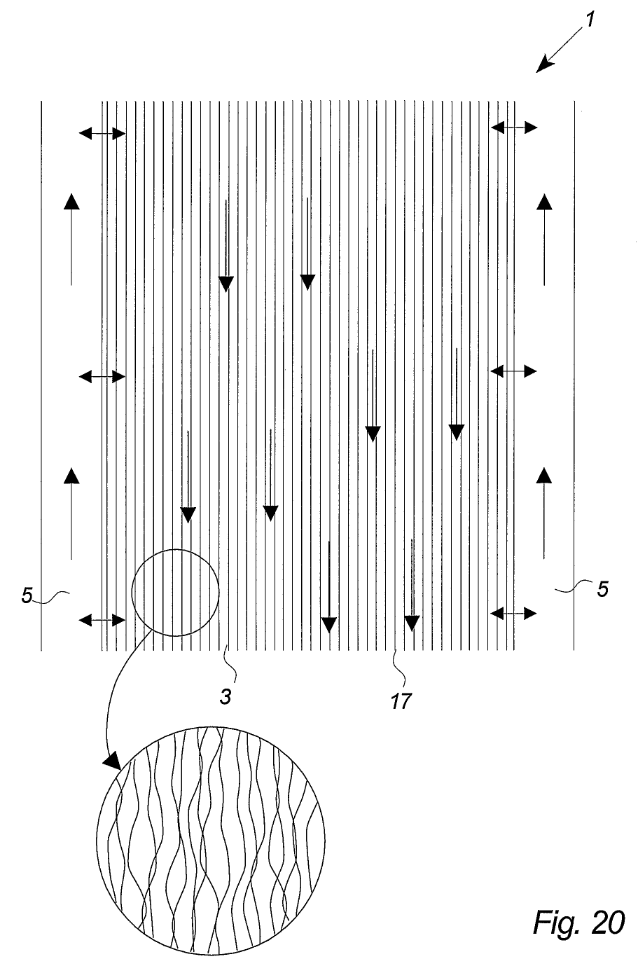

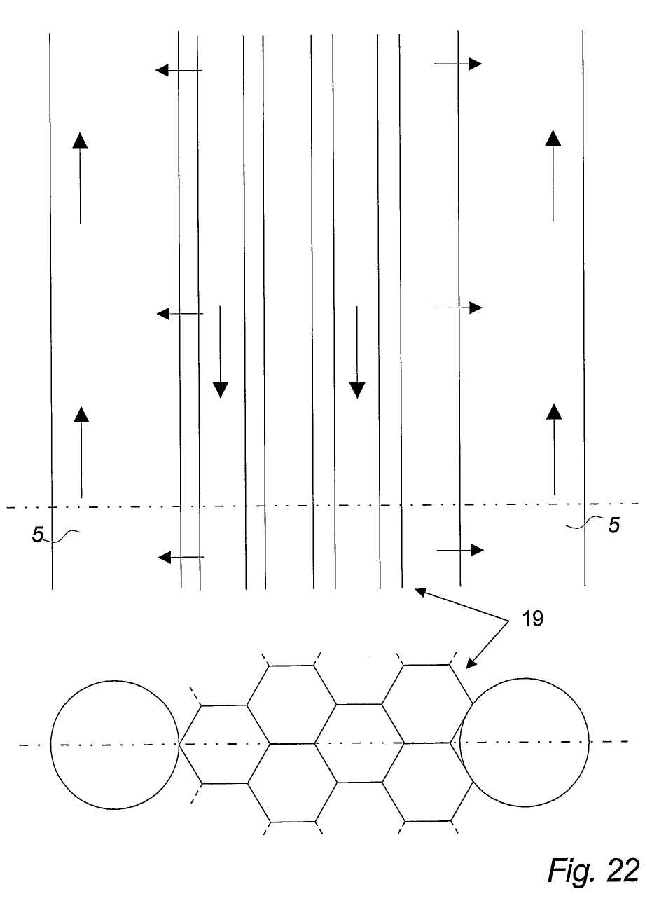

The catalytic material may be deposit on the surface of ceramic, glass or metal fibres that form a tangled bundle of fibres or fibre wool (e.g. as illustrated in FIG. 20). The tangled bundle of fibres or fibre wool may partly or totally fill the passage section but still allows the gas to flow through the passage section. Further, the catalytic material may be deposit on the surface of ceramic, glass or metal surfaces that form a longitudinal monolith structure (e.g. as illustrated in FIG. 22).

In an embodiment the cross-sectional area of said main reaction passage section is between 0.5 and 100 times, such as between 10 and 25 times, preferably about 20 times, the cross-sectional area of said main heat transfer passage section and/or said inlet or outlet passage sections are between 0.5 and 100 times, the cross-sectional area of said main heat transfer passage section.

Further, the cross-sectional area of the main heat transfer passage section is between 0.5 and 10 times, such as 1.5 to 2.5 times, preferably about 2 times, the cross-sectional area of the inlet of the catalytic device, said inlet pipe being the exhaust pipe for the connected internal combustion engine.

The catalyst is not necessarily cylindrical as shown on FIG. 2, 3, 4 or 6 but may be any other shape depending on the requirements dictated by the application which the catalytic device is a part of. Examples of shapes may be spherical, quadrangular, corrugated or further shapes e.g. combinations of shapes or irregular shapes.

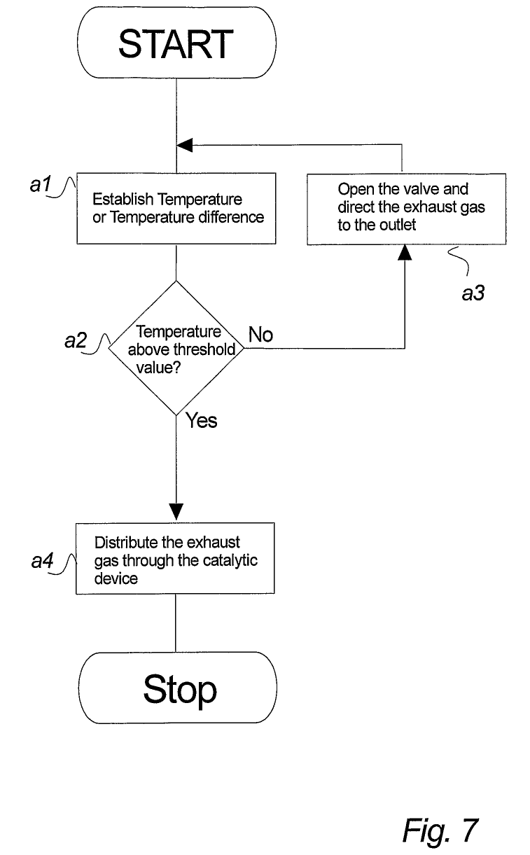

FIG. 7 illustrates a flow diagram of an embodiment.

The flow diagram illustrates the treatment of the exhaust gas in which one or more temperatures of the catalytic device controls the flow path of the gas.

The temperature or temperatures may be measured inside one or more of said passage sections, one or more turning chambers and/or said inlet. The temperature is compared with a pre-established temperature threshold value. A temperature below a threshold value will establish a connection to the outlet of the catalytic device (e.g. through a valve as will be explained in the text below). Temperature below the temperature threshold value will usually occur in a short time period at the start-up of the catalytic device. The exhaust gas will during the period react with the catalytic material in the main reaction passage section and thus causing an increase in the temperature.

The connection will be closed when a higher temperature than the threshold value is achieved and thus force the exhaust gas through the normal path of the catalytic device as will be explained in the text below.

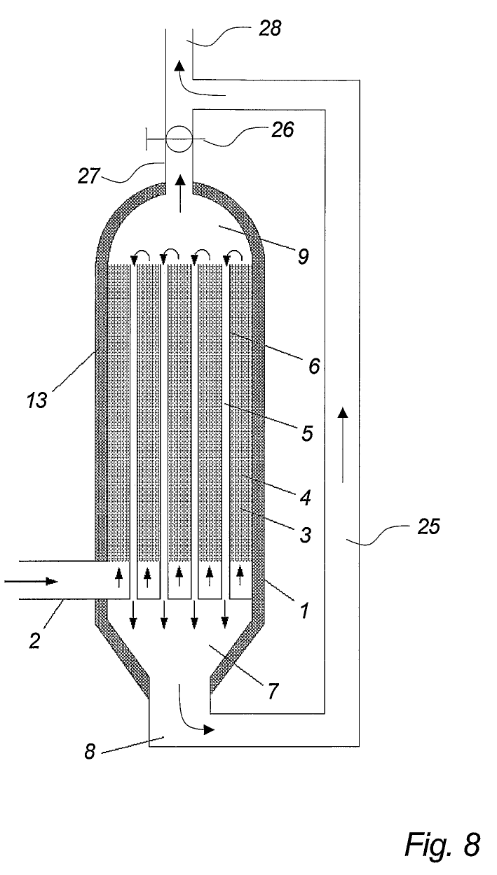

FIG. 8 illustrates a first preferred embodiment of the catalytic device with temperature valve control means.

The figure illustrates a catalytic device 1 corresponding to the device of FIG. 2 in which the inlet 2 is positioned at one side of the device. From the inlet the exhaust gas is initially directed through the first passage (the main reaction passage section 3) to the turning chamber 9. Normally the gas would turn and flow through the further passages but a temperature dependent valve control means 26 is open due to the lower initial temperature of the catalytic device.

The surrounding temperature controls the condition of the temperature dependent valve control means 26. Temperatures below a threshold value will open the valve and a higher temperature will close it.

The gas will thus initially flow through a valve pipe section 27 including the valve 26 and continue to the exterior via an exhaust pipe section 28. The temperature dependent valve control means 26 will subsequently close as the catalytic reaction in the main reaction passage section 3 quickly heats up the catalytic device. The gas will hereafter follow a normal path through the catalytic device e.g. as described in connection with the FIGS. 2 and 3. When the gas reaches the outlet chamber 7 it is transferred to an outlet pipe section 25 which directs the gas to the exhaust pipe section 28 in front of the now closed temperature dependent valve control means 26.

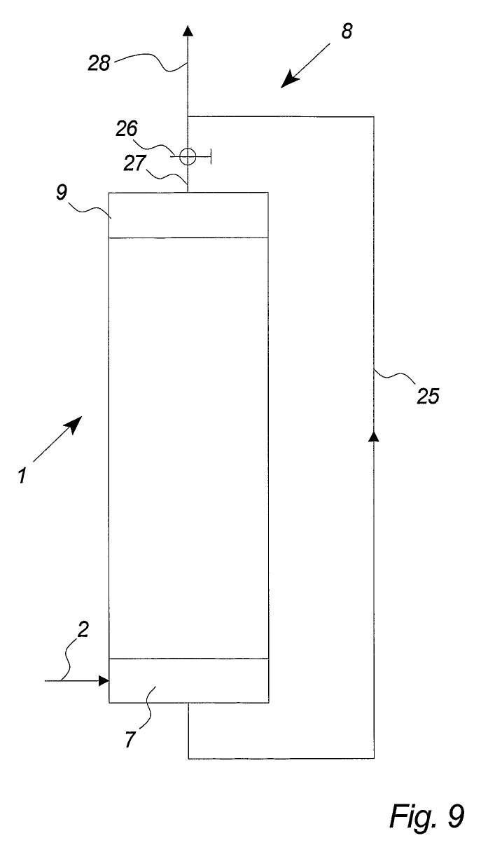

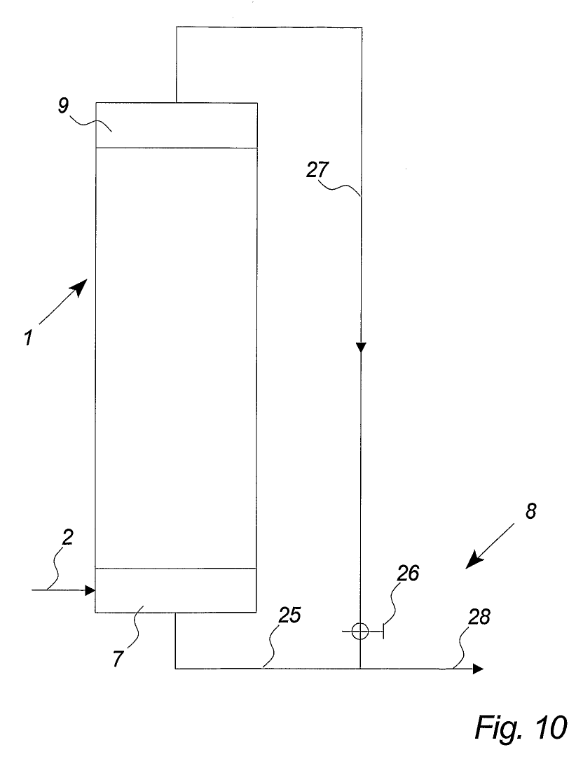

FIGS. 9 and 10 illustrate schematically preferred embodiments including a temperature dependent valve control means 26.

FIG. 9 illustrates the temperature dependent valve control means 26 in a position corresponding to the illustrated in FIG. 8. However, the catalytic device 1 as such may be any catalytic device e.g. one of the devices illustrated in the previous figures.

FIG. 10 illustrates schematically a catalytic device 1 with the temperature valve control means positioned differently.

The figure illustrates how the temperature dependent valve control means 26 can be positioned in proximity of the outlet chamber 7 instead of the turning chamber 9 (illustrated in FIG. 9).

As illustrated in FIGS. 9 and 10 the pipe sections are preferably connected to the catalytic device 1 at the turning chamber 9 and the outlet chamber 7, respectively. Other connection positions are also possible e.g. both connections being at different positions in the outlet chamber. However, the embodiments of the figures are preferred in order to achieve a functionality of the temperature dependent valve control means 26 in which the valve responds quickly to temperature changes.

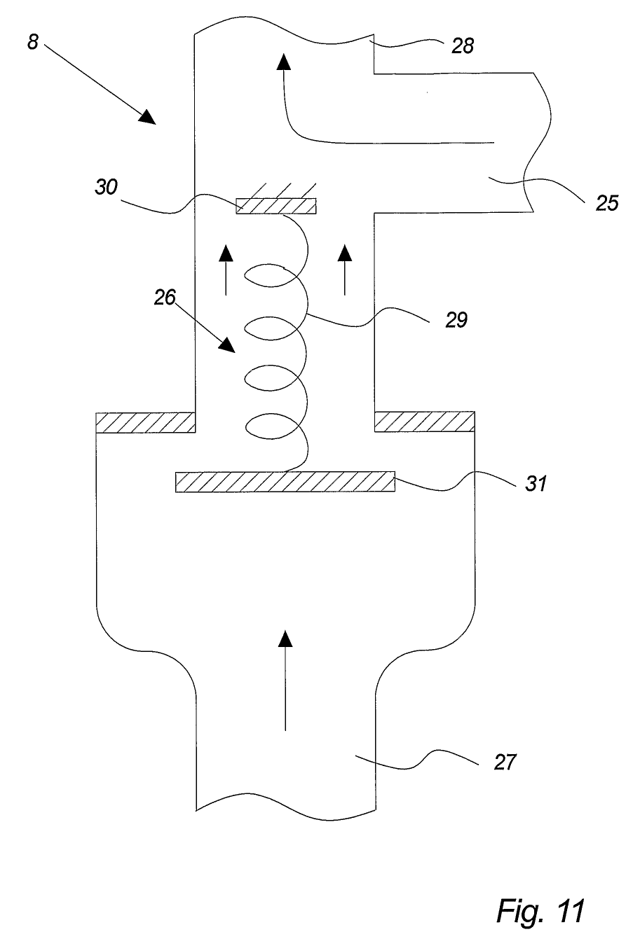

FIG. 11 illustrates a preferred embodiment of the temperature valve control means. The valve includes an anchoring point 30 and a closing member 31 for the valve control means which are mutually connected by temperature dependent connection means 29. The temperature dependent connection means 29 may be chosen between a number of different components comprising the characteristic of changing size at temperature exposure.

The figure illustrates an example with the temperature dependent connection means 29 as an internal and passive solution involving a helical formed spring or coil. The spring is preferably made in a bimetal that will contract at temperatures above a threshold value.

The closing member 31 will be pulled closer to the anchoring point 30 at a rising temperature as the temperature dependent connection means 29 connects the two. The closing member 31 will be retracted to a position in which it closes the opening illustrated in figure at a temperature above the threshold value.

The functionality of the valve is:

1) The valve 26 controls the flow through the catalytic device. When the valve 26 is open, the exhaust gas flows from the inlet through a fewer number of passage sections of the catalytic device and directly to the outlet pipe section. When the valve 26 closes, the exhaust gas is forced down through the necessary or desired sections of the catalytic device.

2) The valve 26 closes when the desired temperature in turning chamber 9 is achieved which preferably will mean when the catalytic device is working.

3) The valve 26 can as mentioned above be controlled by a bimetal spring 29 that closes at a high temperature (a ramp closing over a temperature interval). The bimetal spring 29 is preferably placed so that it is kept warm by the exhaust gas flowing from the outlet pipe section 25 when the valve is closed.

The temperature dependent connection means 29 may also be established by a partly external and active solution involving temperature measurements and electric power supply for the valve 26.

The valve 26 can be controlled by temperature measurements in the turning chamber 9 and the valve closes when the temperature is above a pre-established temperature value. Measuring the temperature difference between the turning chamber 9 and the inlet or the inlet pipe 2 can also be used in controlling the valve 26. When the temperature in the turning chamber 9 exceeds the temperature in the inlet or the inlet pipe 2, the valve closes.

The temperature signals are supplied to the electric power supply which establishes a power signal to the means controlling the valve e.g. magnetic means controlling the position of the closing member 31.

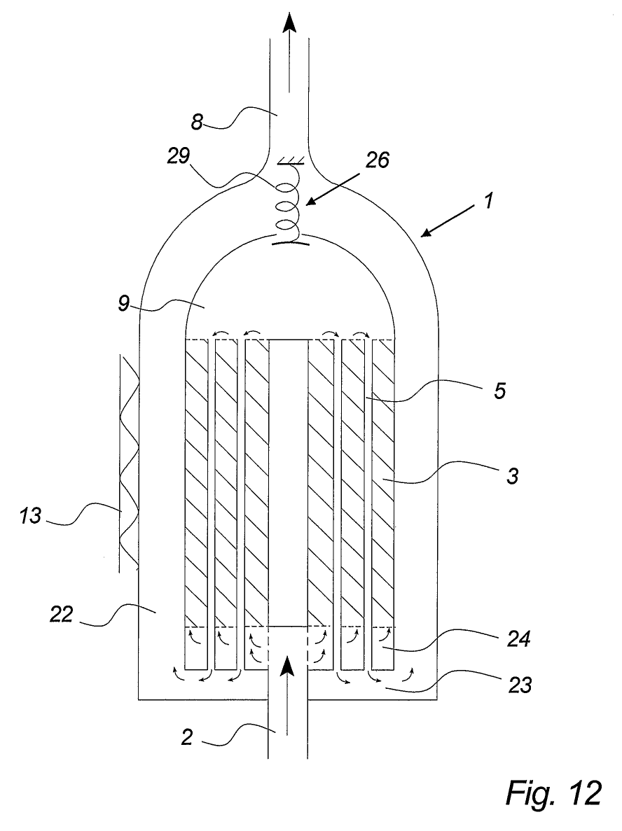

The valve opening may be the entrance to the valve pipe section 27 or an opening in the valve pipe section 27. Further, the valve opening and the temperature dependent valve control means 26 may be an integrated part of the catalytic device as will be explained in connection with FIG. 12.

FIG. 12 illustrates the integration of the temperature valve control means 26 in an embodiment of the catalytic device 1.

The turning chamber 9 is illustrated with an opening allowing gas to enter from the turning chamber 9 to the outlet passage section 22 and the outlet pipe 8. The temperature dependent valve control means 26 is positioned in the opening in order to control the accessibility between the turning chamber 9 and the outlet passage section 22. The opening defined by the chamber walls may comprise a metal lining or a similar material to establish an airtight closure between the walls and the closing member 31.

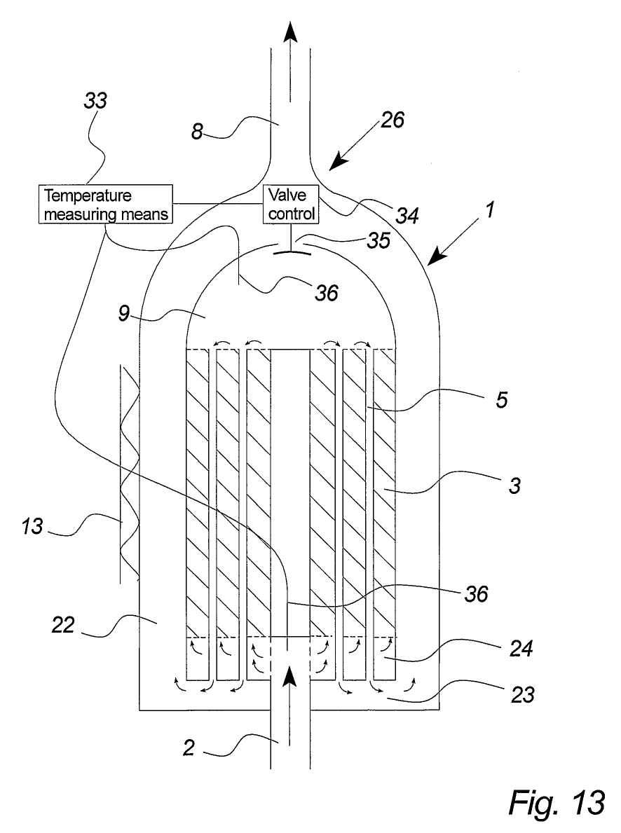

FIG. 13 illustrates an embodiment in which the temperature probes 36 are positioned inside one or more of said passage sections, one or more turning chambers and/or said inlet. The probes are connected to temperature measuring means 33. The temperature measuring means 33 establishes control signals that control the valve 26 through valve control means 34. The valve control means 34 may e.g. be the power supply of the valve.

FIG. 14 illustrates a further preferred embodiment of the catalytic device. The figure illustrates an embodiment with a fourth passage surrounding the three passages e.g. the three passages of the catalytic device 1 illustrated in FIG. 3. In the inlet passage 11 a catalytic device for NOx-reduction can be placed. In the main reaction passage section 3 an oxidation of CO, unburned fuel, such as unburned hydrocarbons, and possibly particles (PM) takes place. In the main heat transfer passage section 5 a heat exchange with passage 3 takes place that increases the temperature to a maximum in 9. In passage 22 an additional heat exchange with passage 11 takes place and insulation can be eliminated or minimised as 22 protects against heat loss from the passage 11 and the passage 11 protects against heat loss from passages 3 and 5. The fourth passage is illustrated as a last of the outlet passage sections 22 in which the passage transfers the gas to the outlet pipe 8.

Generally, the outlet 8 or outlet pipe 8 should be understood as a term defining the outlet of the catalytic device e.g. including the pipe sections 25-28.

Generally, the term “opening” in connection with the valve e.g. “the opening 35” should be understood as the opening that the valve opens or closes.

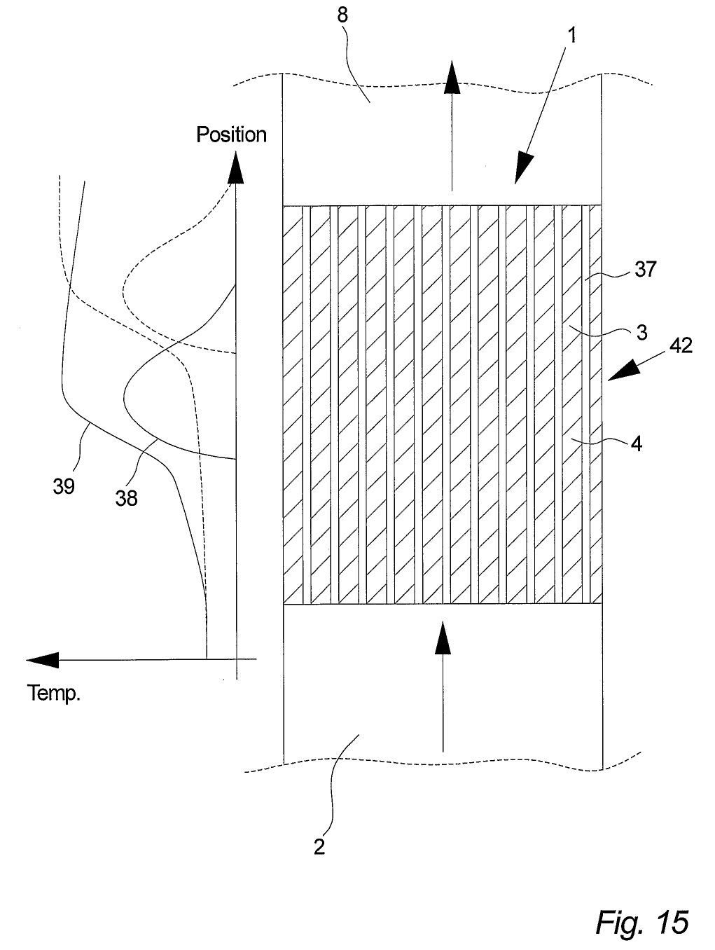

FIG. 15 illustrates a further embodiment of a catalytic device according to the invention and especially a cross-sectional view of the catalyst 1 with one reaction passage section 3. From the inlet 2 the gases pass into the passage 3 with catalytic materials 4 (illustrated as hatched areas) in which the gases react if the temperature is above a certain level and then out through the outlet 8.

In this embodiment of the invention a number heat transferring rods and/or plates 37 are placed inside the catalyst 1 to help controlling the temperature inside the catalyst 1. When the temperature in the catalyst 1 is above a certain level the catalytic process starts and due to the gas flow direction the temperature will typically be highest at the outlet 8 of the catalyst 1. The catalytic process heats up the gases which heats up the heat transferring rods and/or plates 37. The rods and/or plates 37 will then transfer the heat towards the inlet 2 of the catalyst and heat up the incoming gases. By this the incoming gas reaches said certain temperature level closer to the inlet 2, which means that either the gas flow can be increased or the catalyst 1 can be made smaller than if it was made without the heat transferring rods 37.

The heat transferring rods and/or plates 37 is made of a material with god heat transferring qualities such as copper, aluminium, steel or other metals.

In another embodiment of the invention the catalytic materials 4 could be a monolith with the heat transferring rods and/or plates 37 casted into the monolith.

The solid curve 38 in the diagram beside the catalyst 1 displays the progress of the catalytic process and the solid curve 39 displays the temperature of the gases as they pass through the catalyst 1. Because of the heat transferring rods and/or plates 37 the temperature of the gases rise relatively fast making the catalytic process take place close to the inlet 2 of the catalyst 1. The curves shown in dotted line displays where the same process could take place if the catalyst 1 was not equipped with heat transferring rods and/or plates 37.

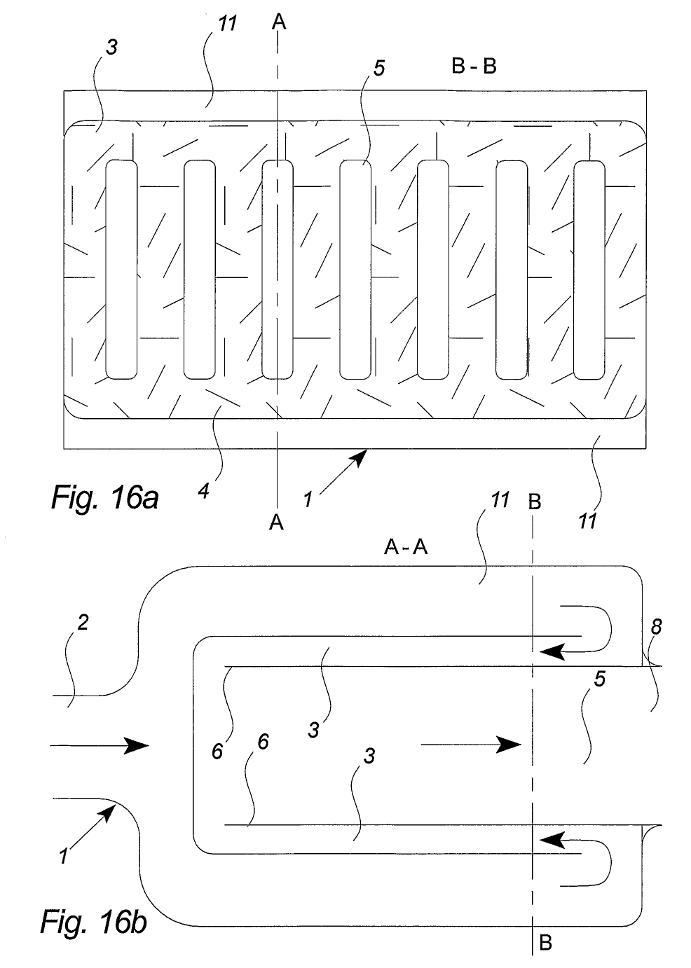

FIGS. 16a and 16b illustrate a further embodiment of the catalytic device. The catalytic device comprises a rather quadrangular shape.

FIG. 16a illustrates the catalytic device (B-B sectional view) in which the inlet passage section 11 is divided into two outer parts positioned on top and on bottom of the second passage section. The main reaction passage section is partly or totally filled with carrier means such as tangled bundle of fibres or fibre wool or any other carrier means deposited with catalytic material 4 (illustrated with a hatched area). Inside the main reaction passage section a number of aligned pipes of a main heat transfer passage section are positioned such as 7 aligned pipes. The pipes of the main heat transfer passage section are further spaced apart with the same distance in order to avoid gas pressure build up occurring in a part of the main reaction and the main heat transfer passage section. The main heat transfer passage sections comprise a quadrangular shape with rounded corners. It shall be emphasized that the number of aligned pipes may be changed to any advantageous number such as between 5 and 100 pipes.

FIG. 16b illustrates the A-A sectional view of the catalytic device illustrated in FIG. 16a. The figure illustrates how the inlet passage section after the inlet 2 divides into the two separate parts of the inlet passage section 11. Each parts of the inlet passage section 11 is connected to a main reaction passage section 3 that is directed along the inlet passage section 11 with a wall in common. As the gas will flow in opposite direction in the inlet and the main reaction passage section, respectively, it is possible to establish a heat exchange through the common wall. The main reaction passage 3 ends in a common main heat transfer passage section 5 that once again directs the gas in the opposite direction allowing the gas in the main reaction and the main heat transfer passage section 3, 5 to heat exchange through a common wall 6. After passing through the main heat transfer passage section, the gas is directed to the outlet 8.

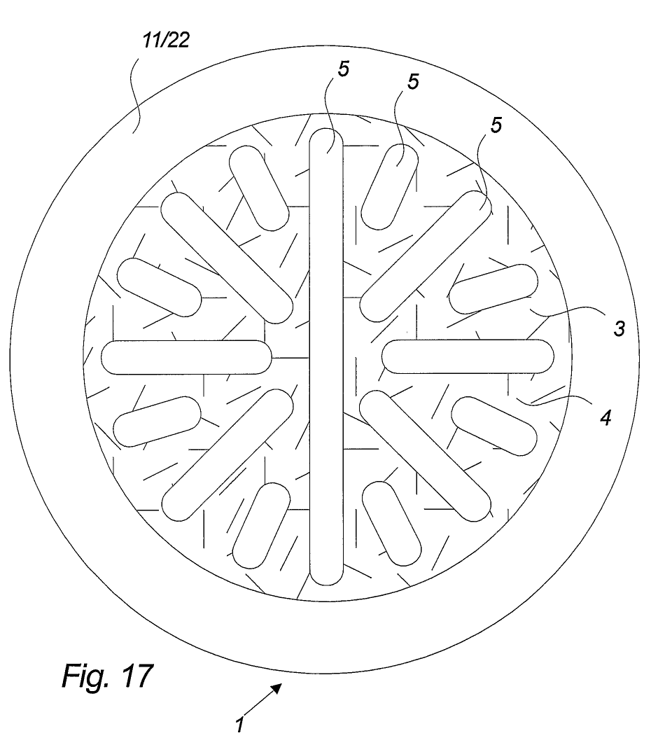

FIG. 17 illustrates a sectional view of an even further embodiment of the catalytic device. The catalytic device is cylindrical with a circular cross section.

The circular cross section illustrates the outer inlet or outlet passage section 11, 22 fully surrounding the main reaction and the main heat transfer passage sections 3, 5 in which the main heat transfer passage section is integrated into the reaction passage section. The main heat transfer passage sections comprise rather ellipsis shaped cross sections in which the height of the sections is different for some of the main heat transfer passage sections. With the different sizes it is possible to fill out most of the second passage section with third passage sections.

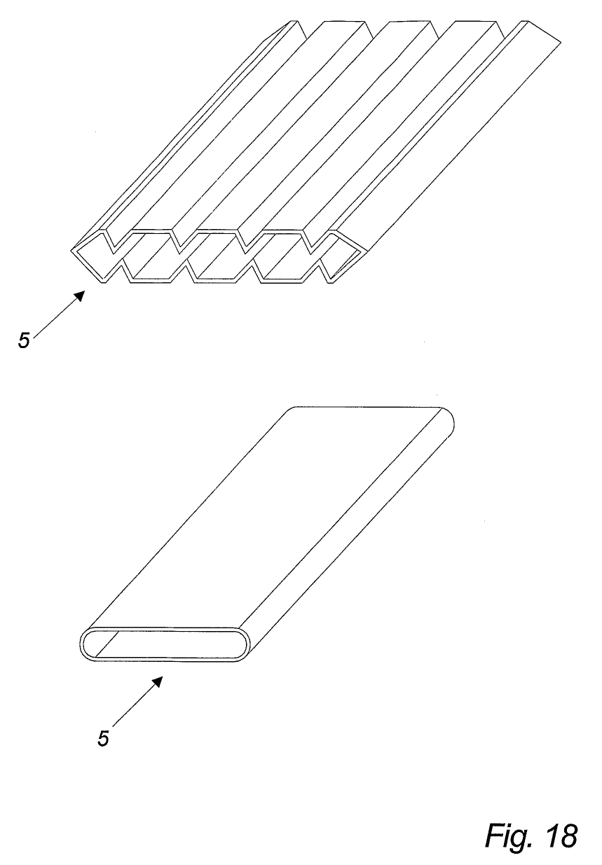

FIG. 18 illustrates a section or pipe of a passage section with a corrugated and a smooth surface shape. With the corrugated section shape it is possible to establish a larger surface but also with a larger pressure loss than the smooth surface shape. The size of the illustrated cross sections-width and/or height as well as the number and depth of the corrugations-may be varied in order to achieve preferred embodiments of the catalytic device according to the invention.

Further, the corrugated and the non-corrugated section are illustrated with an angular or edged surface indicating that the sections are manufactured in one metal plate. The plate is bend into shape and subsequently joined together e.g. by welding.

The passage section also comprises a number of indentations in the surface in which the indentations are illustrated as longitudinal and parallel in the direction of the section. However, the indentations may also be diagonal in relation to the direction of the section and cross-layered from plate to plate.

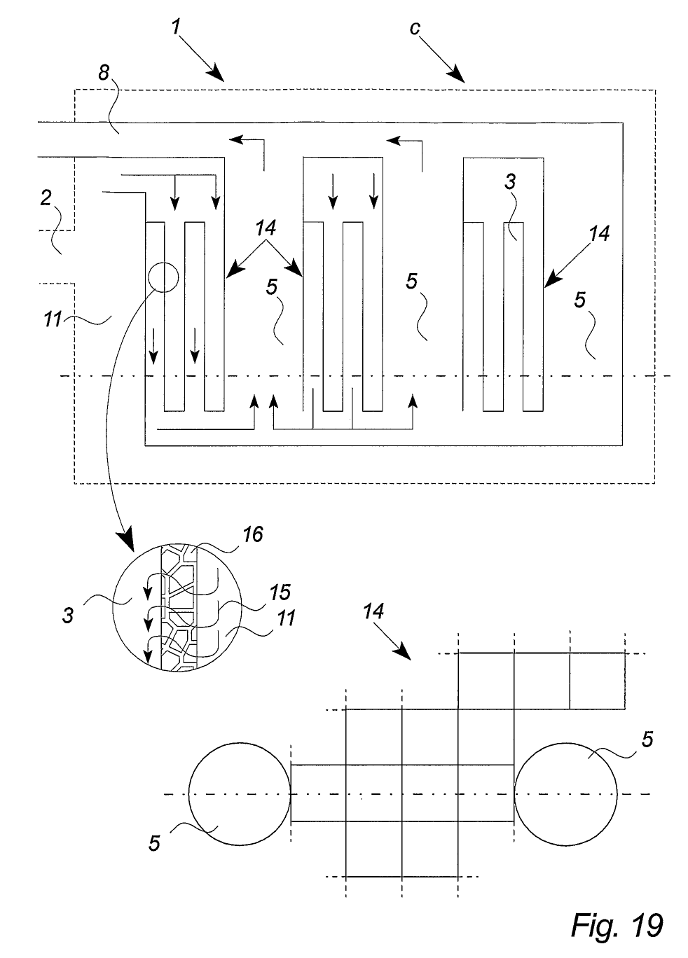

FIG. 19 illustrates a special embodiment in which a wall flows filter 14 is integrated into the catalytic device.

The wall flow filter 14 is integrated into the container c of the catalytic device 1 in the main reaction passage section. With the positioning of the wall flow filter, a number of common channels are established between the filters that work as main heat transfer passage sections 5. The inlet passage section 11 is shown with a dotted line in order to illustrate that the section surrounds the rest of the sections. The inlet passage section is connected to the main reaction passage section 3 in which the section comprises the wall flow filter. The (numerous) common walls 16 between the inlet and outlet of the filters are porous allowing the gas 15 to penetrate from the inlet to the outlet. The common walls comprise catalytic material on the surface, integrated in the wall or a combination hereof allowing the gas to be purified in the passage of the filter.

The filter is preferably a number of parallel pipes or the like establishing a triangular, chessboard (as illustrated in the figure) or honeycomb cross-section patterns as a type of monolith. The pipes are all closed in one end in which some pipes are closed in the opposite end of the end that the gas enters and the rest are closed in the end in which the gas enters.

The heat exchange through the walls, porous or non-porous, ensures that heat is exchanged between the gas in the respective passage sections.

FIG. 20 illustrates a sectional view of a passage section which includes a number of carrier means in the shape of longitudinal fibres deposited with catalytic material.

The figure illustrates that the main reaction passage section is filled with a large number of thin longitudinal fibers 17 as well as pipes 5 of the main heat transfer passage section. The fibers comprise catalytic material 4 on the surface where the gas flows by and reacts with catalytic material 4.

The magnified sectional view illustrates that the fibres still form a tangled bundle of fibres or fibre wool but are substantially extended in a longitudinal direction. With the preferred direction of the fibres it is possible to minimize the pressure loss through the passage section. The bundle of fibres may also extend in other directions or just freely but with a higher pressure loss as the gas flow will experience a higher flow resistance.

In order to enhance the catalytic process, the deposit surface must be as large as possible. Especially with the use of fibres including catalytic material 4 on the outer surface it is possible to achieve large surfaces and a good heat transfer through the main reaction passage section toward the walls transferring the heat to other passage sections.

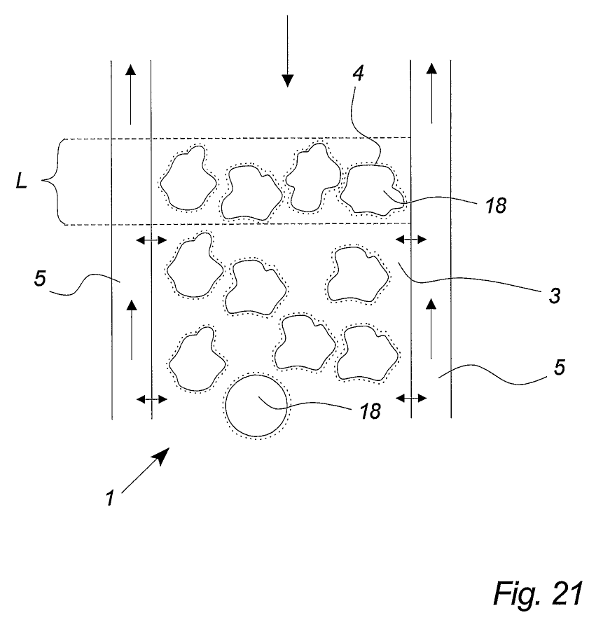

FIG. 21 illustrates a sectional view of passage sections including a number of carrier means deposited with catalytic material.

The carrier means are illustrated as a number of regular or irregular pellets or balls 18 coated with catalytic material 4. The carrier means are positioned in layers (a layer L illustrated with dotted lines on the figure) across one of said passage sections, each of said layers comprises 2 to 6 pellets, such as 2 to 4 and preferably 2 or 3 between adjacent pipes 5.

The carrier means may also be other shapes such as spherical, cylindrical or quadrangular shapes as well as saddle, ring or any further regular or irregular shapes. With the use of pellets, e.g. comprising a ball or other shapes, it is possible to achieve large surfaces and a good heat transfer through the main reaction passage section toward the walls transferring the heat to other passage sections.

The carrier means 18 are preferably made in metal, ceramic, glass or other heat resistant materials as well as combinations of the mentioned materials.

FIG. 22 illustrates sectional view of a passage section comprising a longitudinal monolith structure. The structure comprises very thin pipes or walls positioned in a pattern such as a honeycomb pattern as illustrated.

The pipes of the main heat transfer passage section 5 are fully surrounded by the honeycomb structure of the main reaction passage section 3.

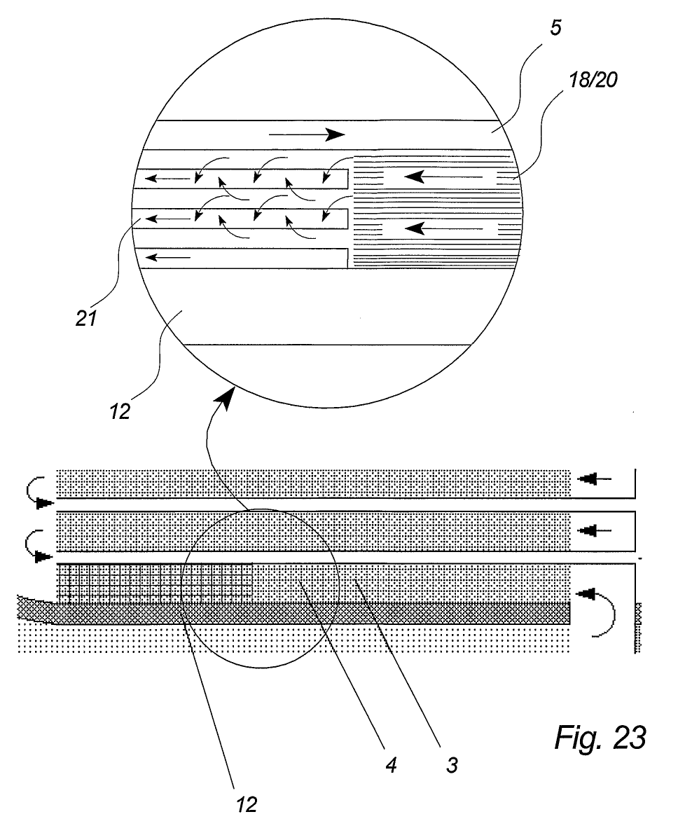

FIG. 23 illustrates a sectional view of a passage section comprising a structure with wall flow filters and longitudinal fibres 20. It shall be emphasised that other types of carrier means such as the above mentioned may replace the fibres.

The main reaction passage section is divided into two parts in which one part is filled with one or more wall flow filters (e.g. ⅓) and the other part with longitudinal fibers. The section may also be divided into further parts that may be filled by any preferred carrier means.

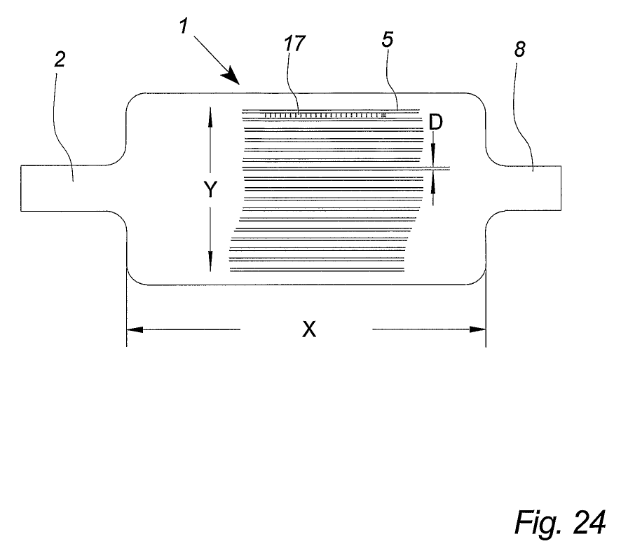

FIG. 24 illustrates schematically an embodiment of the catalytic device including different characterizing data of the device.

The catalytic device comprises a length X and a height or diameter Y. Further, the device comprises a number of carrier means, said means having a size D.

In a first embodiment that preferably is used in an application involving a gas engine e.g. in connection with a combined power and heat plant, the plant may have a nominal electric effect of 30 kW.

The length X is approximately 1.0 meter and the height or diameter Y is approximately 0.3 meter. The UHC value (unburned hydrocarbon) is between 3 and 8% of the firing rate to the engine.

An application with a gas engine may in a preferred embodiment include a catalytic device with at least 50 pipes in a passage section as illustrated in FIGS. 2, 3, 4, 6, 12, 13 or 14. The diameter of the pipes is approximately 6 to 8 millimeters.

In a second embodiment that preferably is used in an application involving a gas engine e.g. in connection with a combined power and heat plant, the plant may have a nominal firing rate of 800 kW.

The length X is approximately 1.2 meter and the height or diameter Y is approximately 1.0 meter. The UHC value (unburned hydrocarbon) is between 3 and 8% of the firing rate to the engine.

An application with a gas engine may in a preferred embodiment include a catalytic device with at least 200 pipes in a passage section as illustrated in FIGS. 2, 3, 4, 6, 12, 13 or 14. The diameter of the pipes is approximately 8 to 12 millimeters.

In a third embodiment that preferably is used in an application involving an internal petrol fuelled combustion engine e.g. in connection with vehicles.

The length X is approximately 0.2 to 0.4 meter and the height or diameter Y is approximately 0.2 meter.

The UHC value (unburned hydrocarbon) is between 0.5 and 5% of the firing rate to the petrol combustion engine. The value can in a preferred embodiment be raised to approximately 5 to 10% in order to achieve higher temperatures inside the catalytic device by burning further hydrocarbons inside the device. Higher temperatures in the catalytic device mean that catalytic material is saved. Higher values than 10% of the firing rate will affect the efficiency of the petrol combustion engine.

An application with a petrol combustion engine may in a preferred embodiment include a catalytic device with at least 50 pipes in a passage section as illustrated in FIGS. 2, 3, 4, 6, 12, 13 or 14.

In a fourth embodiment that preferably is used in an application involving internal diesel fuelled combustion engine e.g. in connection with vehicles.

The length X is approximately 1 meter and the height or diameter Y is approximately 0.3 meter.

The UHC value (unburned hydrocarbon) is normally between 0.5 and 3% of the firing rate of the diesel combustion engine but can in a preferred embodiment be raised to approximately 5% in order to achieve higher temperatures inside the catalytic device by burning further hydrocarbons inside the device.

Especially, in order to remove the ultra fine particles efficiently from the diesel exhaust gas, it is necessary to use catalytic material coated on very large surfaces such as the embodiment illustrated in e.g. FIG. 20 or 23.

It shall be emphasized that the above-mentioned embodiments are only examples of applications in which the catalytic device can be used. Further, the data of the embodiments are only examples of values that may be used in specific applications. In the applications and in other applications different data and values may also be used if found suitable.

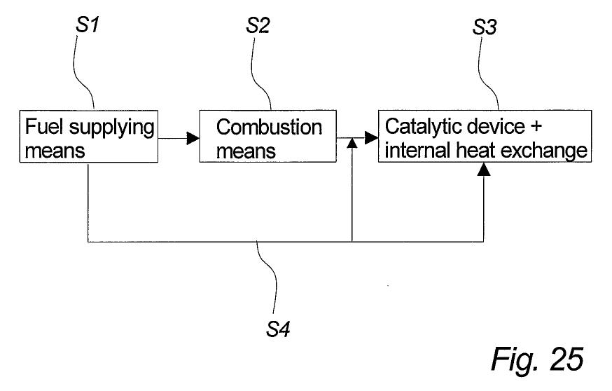

FIG. 25 illustrates a further application including a catalytic device.

The application involves the means of FIG. 1 in which a fuel supply line S4 is added between the fuel supplying means and the catalytic device. The line is added in order to illustrate the possibility of raising the UHC value in the gas by supplying (unburned) fuel to the catalytic device. The fuel may be delivered to the catalytic device and the entered gas by a separate valve or spout in the catalytic device, or simply by controlling the combustion process of the combustion engine allowing the exhaust gas to achieve a higher UHC value.

The fuel supply line S4 may also deliver the extra fuel to a position in between the fuel supplying means and the catalytic device. For example may the fuel be added to the exhaust gas just before entering the catalytic device e.g. by spraying the fuel into the exhaust gas.

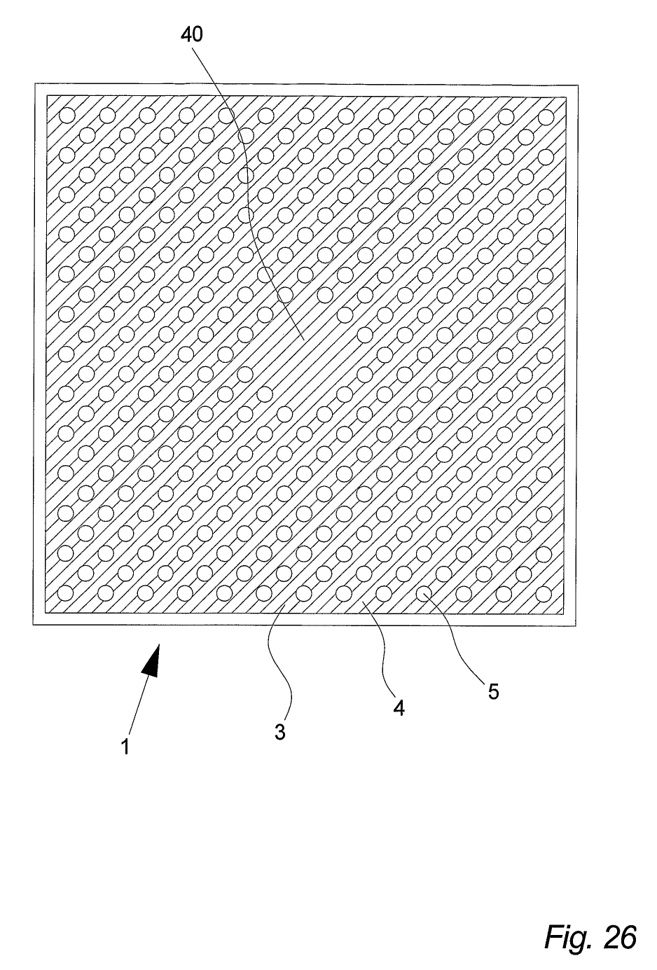

FIG. 26 illustrates an embodiment of a catalytic device 1 as seen from above. The catalyst 1 comprises catalytic materials 4 (illustrated as hatched area) and heat transfer passages 5. The catalyst 1 is provided with a free space 40 somewhere in the catalyst 1 and preferably in the or close to the middle of the catalyst 1. The catalyst 1 is not equipped with heat transfer passages 5 in this space 40 which enables that the catalytic materials 4 can be removed from the catalyst 1 by means of a vacuum cleaner or the like.

The catalytic materials 4 become ineffective over time and in large industrial catalysts 1 known in the art the catalytic materials 4 has to be changed once in a while. This is typically done by dismantling the catalyst or by removing the catalytic materials 4 through the bottom of the catalyst 1. By providing the catalyst with a free space 40 a vacuum cleaner hose can get all the way to the bottom of the catalyst 1.

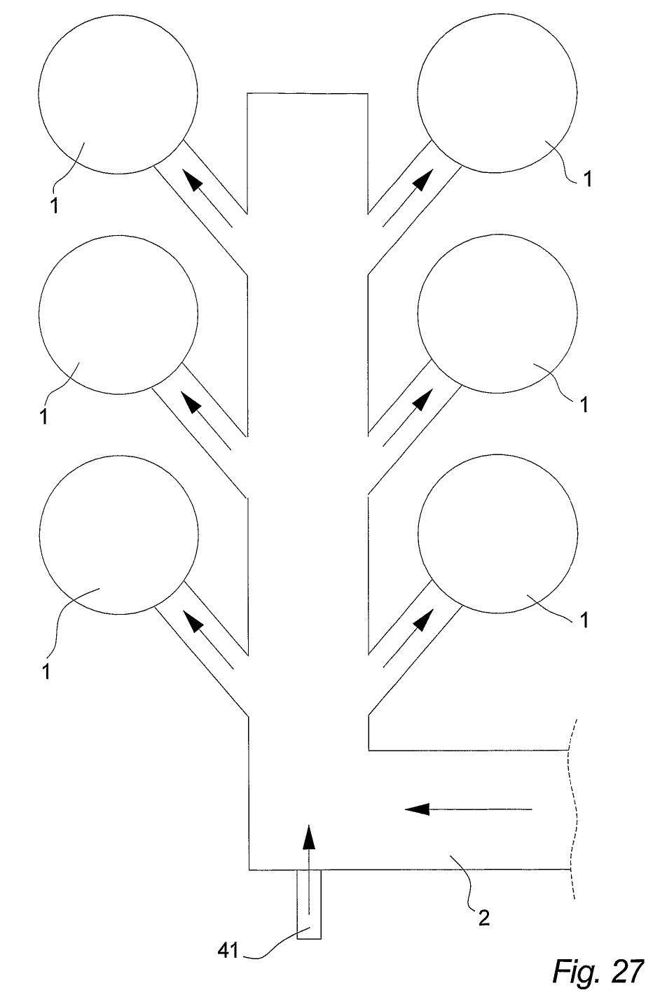

FIG. 27 illustrates an array of catalytic devices 1 in a large plant using a plurality of catalytic devices 1 as seen from above. From the inlet 2 the gases are distributed to a number of separate catalysts 1 where the catalytic process takes place. The catalysts 1 become ineffective over time due to soot, unburned material or other covering the catalytic materials or in other ways preventing the catalysts 1 for operating optimally. This residue can be removed by raising the temperature in the catalysts 1. This is done by adding a highly flammable gas such as e.g. propane to the gases via the flammable gas inlet 41. The added gas will burn in the catalysts 1 and hereby raising the temperature and burning all the material or covering in the catalysts 1 preventing them from functioning properly.

The figures are not of dimensional accuracy, and all dimensions and materials must be determined for the actual use.

The invention has been exemplified above with reference to specific examples. However, it should be understood that the invention is not limited to the particular examples described above but may be used in connection with a wide variety of applications. Further, it should be understood that especially the shapes of the catalytic device and especially the passage sections according to the invention may be designed in a multitude of varieties within the scope of the invention as specified in the claims.

### LIST

1. Catalytic device or catalyst

2. Inlet or inlet pipe

3. Main reaction passage section

4. Catalytic material of one or more kinds

5. Main heat transfer passage section

6. Heat exchange surface

7. Outlet chamber

8. Outlet pipe

9. Turning chamber

10. Inlet chamber

11. One or more inlet passage sections

12. Inner layer of insulation

13. Outer layer of insulating

14. Wall flow filters

15. Gas quantity

16. Porous wall

17. Carrier means in the form of longitudinal monoliths or fibres

18. Carrier means in the form of irregular spheres such as pellets or balls

19. Longitudinal monolith structure

20. Longitudinal fibre structure

21. Wall flow filter

22. One or more outlet passage sections

23. Second turning chamber

24. Inlet distribution space

25. Outlet pipe section

26. Temperature dependent valve control means

27. Valve pipe section

28. Exhaust pipe section

29. Temperature dependent connection means

30. Anchoring point for the valve control means

31. Closing member for the valve control means

32. Common passage chamber

33. Temperature measuring means

34. Valve control

35. Opening

36. Temperature probe

37. Heat transferring rods and/or plates

38. Solid curve displaying the rate of the catalytic process

39. Solid curve displaying the temperature of the gases

40. Free space

41. Flammable gas inlet

42. Passage section

a1-a4. Flow items

c. Container

h. Heat exchanger

L. Layer of regular or irregular pellets

S1. Fuel supplying means e.g. fuel pump

S2. Combustion device e.g. combustion engine

S3. Catalytic device

S4. Fuel supply line

1-79. (canceled)

80. Method for treatment of a fluid quantity including chemical reacting means such as combustible materials above a certain minimum quantity in a high heat capacity catalytic device, said method comprising:
entering said fluid quantity into the catalytic device through an inlet,
controlling a temperature in one or more passage sections of said catalytic device including at least one reaction passage section,
establishing said high heat capacity by high mass of the device in relation to mass flow of the fluid, said device including heat transferring rods, plates and/or substantially parallel pipes at a number between 20 and 5000, and
emitting the treated fluid quantity from the catalytic device through an outlet.

81. Method according to claim 80 wherein said at least one reaction passage sections heat exchange with a main heat transfer passage section, and/or where said at least one reaction passage sections heat exchange with one or more preceding inlet passage sections and/or one or more succeeding outlet passage sections.

82. Method according to claim 80 wherein the fluid quantity is directed through the succeeding passage sections in counterflow.

83. Catalytic device for treatment of a fluid quantity including chemical reacting means such as combustible materials above a certain minimum quantity, said device comprising:
at least one inlet and outlet for said fluid quantity, and
one or more passage sections including at least one reaction passage section comprising catalytic material of one or more kinds,
integrated heat transfer means for controlling temperature in one or more of said at least one passage sections,
wherein said integrated heat transfer means is configured to control the temperature by high heat capacity established by high mass of the device in relation to mass flow of the fluid, and
wherein said integrated heat transfer means includes heat transferring rods, plates and/or substantially parallel pipes at a number between 20 and 5000.

84. Catalytic device according to claim 83, wherein said catalytic device comprises at least two passage sections.

85. Catalytic device according to claim 83, wherein said device includes at least one outer layer of insulating.

86. Catalytic device according to claim 84, wherein said integrated heat transfer means include positioning of said passage sections in order to form at least one internal heat exchanger with mutual heat exchange between the sections.

87. Catalytic device according to claim 84, wherein said at least one reaction passage sections establishes a heat exchanger with a main heat transfer passage section, and/or said at least one reaction passage sections establishes a heat exchanger with one or more preceding inlet passage sections and/or one or more succeeding outlet passage sections.

88. Catalytic device according to claim 87, wherein said reaction passage section is positioned above, alongside or outside said main heat transfer passage section by surrounding said section, said reaction passage section heat exchanges with said main heat transfer passage section of said at least two passage sections and/or said reaction passage section heat exchanges with said main heat transfer passage section in counterflow.

89. Catalytic device according to claim 87, wherein a cross-sectional area of said reaction passage section is between 0.5 and 100 times a cross-sectional area of said main heat transfer passage section and/or said inlet or outlet passage sections are between 0.5 and 100 times, the cross-sectional area of said main heat transfer passage section.

90. Catalytic device according to claim 87, wherein a cross-sectional area of the main heat transfer passage section is between 0.5 and 10 times the cross-sectional area of the inlet (2) of the catalytic device, said inlet pipe being an exhaust pipe for a connected internal combustion engine.

91. Catalytic device according to claim 87, wherein said at least one passage sections comprises one or more substantially parallel pipes.

92. Catalytic device according to claim 91, wherein said main heat transfer passage section is integrated as a number of pipes in said reaction passage section and/or said number of pipes is between 20 and 5000 pipes.

93. Catalytic device according to claim 91, wherein said pipes form symmetrical patterns comprising triangular, quadrangular or similar patterns or random patterns, said pipes are surrounded by catalytic material deposited on one or more carrier means and/or said pipes comprise a circular, an oval, a triangular, a four-sided or any similar regular or irregular cross sectional shape.

94. Catalytic device according to claim 93, wherein said catalytic material is deposited on said one or more carrier means in at least one of said at least one passage sections.

95. Catalytic device according to claim 94, wherein said one or more carrier means are made in metal, ceramic, glass or other heat resistant materials or combinations of the mentioned materials.

96. Catalytic device according to claim 94, wherein said one or more carrier means include at least one shape comprising at least one of spherical, cylindrical, quadrangular, saddle, ring, regular or irregular shapes.

97. Catalytic device according to claim 94, wherein said one or more carrier means include a number of regular or irregular pellets or balls in layers across one of said passage sections, each layer being positioned perpendicularly between two adjacent pipes, and each of said layers comprising 2 to 6 pellets.

98. Catalytic device according to claim 94, wherein said reaction passage section of said at least one passage sections comprises one or more kinds of said catalytic material deposit on said carrier means.

99. Catalytic device according to claim 94, wherein said catalytic material includes metal oxides comprising at least one of Gold (Au), Platinum (Pt), Silver (Ag), Aluminium (Al), Lead (Pb), Zirconium (Zr), Copper (Cu), Cobalt (Co), Nickel (Ni), Iron (Fe), Cerium (Ce), Chrome (Cr), Tin (Sn), Manganese (Mn) and Rhodium (Rh) Oxides or combinations thereof.
